(19) United States
(12) Patent Application Publication
(10) Pub. No.: US 2014/0115664 A1
(43) Pub. Date: Apr. 24, 2014

(54) INSTRUCTION-BASED WEB SERVICE ROUTING SYSTEM THAT ENABLES DEVICES TO CONTROL THE FLOW OF CONTENT

(71) Applicant: Martin Boliek, San Francisco, CA (US)

(72) Inventor: Martin Boliek, San Francisco, CA (US)

(21) Appl. No.: 14/054,413

(22) Filed: Oct. 15, 2013

Related U.S. Application Data
(60) Provisional application No. 61/716,962, filed on Oct. 22, 2012.

(51) Int. Cl. H04L 29/08; H04L 29/06

(52) U.S. Cl. CPC H04L 67/26; H04L 63/08
USPC 726/3; 709/217

(57) ABSTRACT

A method and apparatus is disclosed herein for directing flow of data collected from a data acquisition device on a network are disclosed. In one embodiment, the method comprises directing the flow of data collected from a data acquisition device in response to a connector, where the connector represents a user selected and parameterized workflow template that specifies one or more web services to perform processing on the data or storage of the data, including receiving the data after the data acquisition device pushes the data to the network in response to the connector, and controlling processing flow of the data with at least one of the one or more web services specified by the connector; and storing the data via one of the one or more web services according to the connector.

### PRIORITY

The present patent application claims priority to and incorporates by reference the corresponding provisional patent application Ser. No. 61/716,962, titled, “An Instruction-based Web Service Routing System that Enables Devices to Control the Flow of Content” filed on Oct. 22, 2012.

### RELATED APPLICATIONS

This application is related to the co-pending application entitled Trust Document Scanning and Data Capture, filed on May 2, 2012, U.S. Provisional Patent Application Ser. No. 61/641,735.

### FIELD OF THE INVENTION

Embodiments of the invention generally relate to the field of interfaces between smart specific purpose devices such as printers, scanners and other data capture and consumption devices, computers and other smart devices, and cloud-based services.

### BACKGROUND

In the evolution of the “digital world”, the center of an individual's digital focus is shifting from the personal computer to some combination of computers, smart devices that interact with cloud-based data storage and processing (e.g., Evernote.com, Google Drive). This transformation creates a number of challenges for uploading, downloading, controlling, and synchronizing data between all the devices and the cloud.

Most cloud web services offer multiple interfaces for interacting with devices. Many also offer Application Programming Interfaces (API). There are some cloud services that offer client-side applications that synchronize data between a user's device and that cloud service. The user's account information is a setting in the client-side application allowing seamless interaction with the cloud web service.

However, to interact with the web service, it is necessary to login to the specific cloud service and/or use the appropriate application. Only one service is available at a time. Uploading, downloading, synchronizing, accessing data, or using multiple services in a workflow is difficult to achieve across different cloud services. There is great difficulty viewing in one place all of the data stored on multiple sites.

### SUMMARY OF THE INVENTION

A method and apparatus is disclosed herein for directing flow of data collected from a data acquisition device on a network are disclosed. In one embodiment, the method comprises directing the flow of data collected from a data acquisition device in response to a connector, where the connector represents a user selected and parameterized workflow template that specifies one or more web services to perform processing on the data or storage of the data, including receiving the data after the data acquisition device pushes the data to the network in response to the connector, and controlling processing flow of the data with at least one of the one or more web services specified by the connector; and storing the data via one of the one or more web services according to the connector.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 shows the block diagram of one embodiment of a system for enabling data acquisition devices to push content to the web and control the flow of processing and storage in a variety of cloud web services.

FIG. 2 illustrates connections between these various layers of the system depicted in FIG. 1.

FIG. 3 illustrates an association between a series of user connectors and workflows performed by a system.

FIG. 4 is one embodiment of a graphical user interface illustrating a marketplace of workflow templates.

FIG. 5 illustrates a graphical user interface for managing personalized user connectors of an individual.

FIG. 6 illustrates an example of a graphical user interface representing a capture page.

FIG. 7 illustrates a graphical user interface depicting multiple personal connectors available for performing a drag and drop operation to move captured data into one or more folders.

FIG. 8 illustrates one embodiment of a graphical user interface depicting personalized connectors available for a smart application on a smart device.

FIG. 9 depicts a block diagram of a security gateway.

### DETAILED DESCRIPTION OF THE PRESENT INVENTION

Embodiments of the invention include a software-based system that enables data acquisition devices (such as document scanners, digital cameras, sensors, etc.) to push content to the web and control the flow of processing and storage in a variety of cloud web services. Examples of these cloud web services include, but are not limited to, Evernote, Google Drive, and others that provide a data repository and/or data processing.

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

### Overview

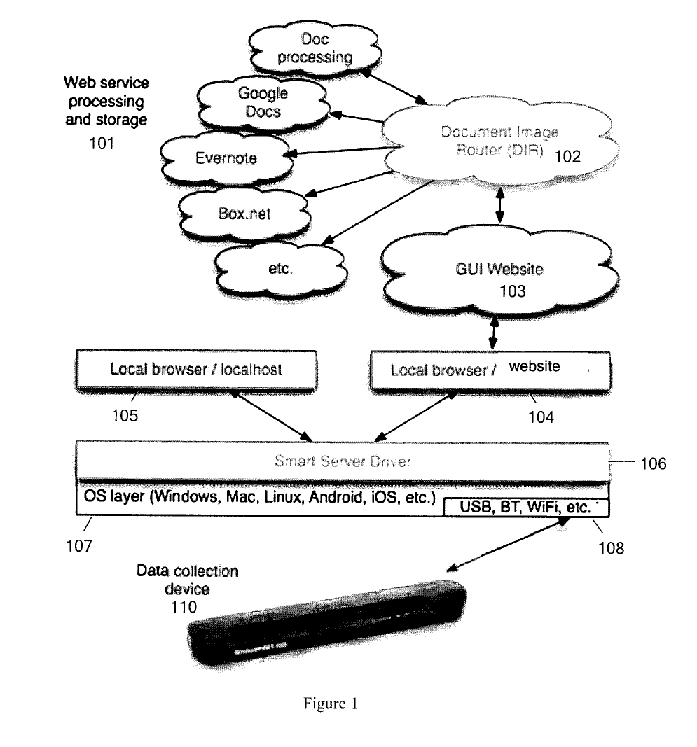

FIG. 1 shows the block diagram of one embodiment of a system for enabling data acquisition devices (e.g., document scanners, digital cameras, sensors, etc.) to push content to the web and control the flow of processing and storage in a variety of cloud web services.

Referring to FIG. 1, in one embodiment, the system has five layers: Smart Server Driver (SSD) 106, GUI Website (GW) 103, Document Image Router (DIR) 102, Web Service Interface (WSI), and Cloud web services 101. Smart Server Driver (SSD) 106 interacts with a data acquisition device, such as data collection device 110 (e.g., document scanner, digital camera, sensor, etc.) directly. In one embodiment, SSD 106 includes an operating system (OS) layer 107 (e.g., Windows, Mac, Linux, Android, iOS, etc.) and a communication interface 108 (e.g., USB, BT, WiFi, etc.) that allows it to communicate with data collection device 110.

In one embodiment, GUI Website (GW) 103 interfaces with SSD 106 through a local browser 104. GW 103 enables a user to create personalized connectors, i.e., instruction sets and to associate those personalized connectors with the acquired data, control data collection device 110 (in some embodiments), and search on the results.

The user connectors, or “instruction sets,” direct data obtained from a data acquisition device through one or more workflows. In one embodiment, the workflows are setup by the user prior to the data acquisition device acquiring the data. The setup by the user makes them personalized to at least that user. In one embodiment, the connectors are uniquely created by the user, accessible via several smart devices and data acquisition devices, can be associated with many kinds of data, and are sufficient to guide the data through the designated workflow.

In one embodiment, the workflows are setup at the time that a particular workflow is selected either before or after capture. This may enable even more options for the users.

In one embodiment, the workflows can be setup and then shared enabling multiple users to capture documents and data to the same workflow. For example, a school can distribute the same user connector to parents, allowing student health documentation to be captured and saved in the same repository system.

In one embodiment, the personalized user connectors include information needed to access the desired cloud web service or services (e.g., login and password information or OAuth key, folders, and tags, data flow, data formats and conversion), information related to the user account (e.g., account ID), and information that helps the user understand the data flow (e.g., nicknames for the instruction set, confirmation instructions, filenames).

In one embodiment, Document Image Router (DIR) 102 defines the possible connectors for GW 103, receives the data and associated personalized connector, executes by interacting with the Web Service Interface (WSI), and provides logging and search engine of the log. The WSI functional software connectors are custom to each web service that is included in the system.

Cloud web services 101, which include web service processing and storage, are provided by third parties. Cloud web services 101 are accessed through various ways such as an Application Programmer's Interface (API). Many document and data services are provided as web services with APIs such as data storage, data sharing, forms processing, ticketing, reservation handling, optical character recognition, invoice processing, and more.

In one embodiment, SSD 106 is controlled, or setup for local control, by GW 103. In one embodiment, functions performed by SSD 106 include: direct control of the data acquisition device, data processing (e.g., image processing, optical code recognition such as bar codes and QR-codes, data formatting and format conversion), interaction with a user editor, encryption, double encryption (see U.S. patent application Ser. No. 13/676,580, entitled “Method and Apparatus for Trust Based Data Scanning, Capture and Transfer,” filed Nov. 14, 2012), logging all transactions for tracking, creating an upload package with the instructions and data, queuing, and uploading the content.

In one embodiment, GW 103 interacts with SSD 106 and DIR 102. GW 103 is the user interactive portion of the system. In one embodiment, GW 103 allows users to create accounts, set up personalized connectors (e.g., instructions) for the flow of content, interact with one or more data acquisition devices, and query the logs on both SSD 106 and DIR 102 to present the status and locations of content to the user. GW 103 receives a content package from SSD 106 and passes it on to DIR 102. In one embodiment, GUI 103 authenticates the source (matching SSD 106 to a user account) before passing the content onto DIR 102.

In one embodiment, GW 103 presents the user with an interface that interacts with SSD 106 in real-time. This interface can control the data acquisition device directly, set capture parameters, and modify the instruction set that is combined with the captured data.

DIR 102 receives the package from GW 103, decrypts the data as necessary (see U.S. patent application Ser. No. 13/676,580, entitled “Method and Apparatus for Trust Based Data Scanning, Capture and Transfer,” filed Nov. 14, 2012), extracts the instructions, calls the appropriate WSI, receives the data back from the WSI, sends acknowledgement to the user via several possible methods (e.g., email, text, website, et.), logs the transactions, and provides status and history to GW 102 when queried.

The WSI sends the content to the appropriate cloud web services, receives return data (if the cloud web services performs processing), and sends the return data and acknowledgement back to the WSI. The data is handled via the API of the third-party web service.

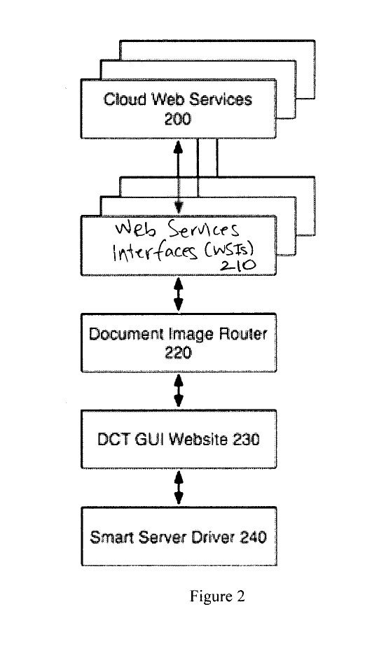

FIG. 2 illustrates connections between these various layers of the system depicted in FIG. 1. Depending on the embodiments, these functions can be implemented on different machines. Referring to FIG. 2, in one embodiment, SSD 240 is implemented in a personal computer and connected to a data capture device (e.g., a sheet-fed scanner) via a USB connection, GW 230 is a website hosted in an Internet accessible host computer, and DIR 220 is tightly coupled with WSI 210 on a web service hosted on a separate Internet accessible host computer. In one embodiment, Cloud Web Services 200 are third-party service all served on Internet accessible host computers.

In one embodiment, SSD 240 runs on a smart device (e.g., computer, tablet device, smart phone, etc.) connected to the data acquisition device. The connection to the data acquisition device can be wired (e.g., USB) or wireless (e.g., 4G LTE, WiFi, Bluetooth). In one embodiment, the SSD is a local host web server with a RESTful interface.

There are many ways to execute SSD 240. In one embodiment, SSD 240 executes directly on the stand-alone data acquisition device. In another embodiment, SSD 240 executes on a smart device (e.g., computer, tablet, smart phone, etc.) that is directly connected to the data acquisition device with either a wired or wireless connection. In yet another embodiment, a folder system is provided on a computer or application data on a smart device where the data can be placed by the OS (e.g., using copy, move, or drag and drop functionality) or a third-party application (e.g., scanner software where the user chooses the right software).

An advantage of having GW 230 and SSD 240 implemented on separate computers, devices, or websites is that the same GW 230 can support several different SSDs. These SSDs can support multiple data capture devices using the same, or multiple, accounts. An advantage of having DIR 220 and GW 230 implemented on separate computers, devices, or websites is that the same DIR can support several different GWs.

The layers of FIG. 2 can be implemented in a variety of ways. For example, in one embodiment all of the four layers (SSD 240, GW 230, DIR 220, WSI 210) are implemented on different computers or smart devices. In another embodiment, all four layers are implemented directly in the data acquisition devices (e.g., a smart wireless scanner). In yet another embodiment, all four layers are implemented in the same computer or cloud web service that is connected to the device directly or via another computer.

In one embodiment, to create the user connectors, the user interacts with the graphic user interface of GW 230 to select the cloud services. WSI 210 has a list of the information needed to make the connections with the cloud services. This list is passed from WSI 210 to DIR 220 and finally to GW 230, where a form of this information, and any other information needed in the user connector, is presented to the user. The user fills out this form and creates the personalized user connector.

In one embodiment, the user connector is sent to, and saved at, DIR 220. An index link to the user connector is available for storing at GW 230 and/or SSD 240, allowing for the user to later associate this user connector with a data set collected at the data acquisition device. In another embodiment, the user connector is sent directly to SSD 240. In yet another embodiment, the user connector is stored in the user account profile at GW 103.

In one embodiment, when the data is captured using the data acquisition device, the captured data is bundled in a file, or otherwise associated, with an user connector or the index link of the user connector at SSD 240. SSD 240 either has this user connector stored or requests it using GW 103.

When using OAuth to authenticate a cloud web service, this process varies a little. The OAuth page requesting the user login and password is launched by GW 103, but the system never sees the data the user enters. Note that when user connectors are created and include individual specific data such as, for example, login and password information, they become personalized for that individual.

Note that the layers described above may be implemented in software that is “ported” to mobile devices. In one embodiment, the mobile devices interact with the data acquisition devices (e.g., a scanner) via a network (either a stand-alone WiFi network or a scanner connected to a computer on a network). In another embodiment, the mobile devices drive the scanner, or other capture device, directly.

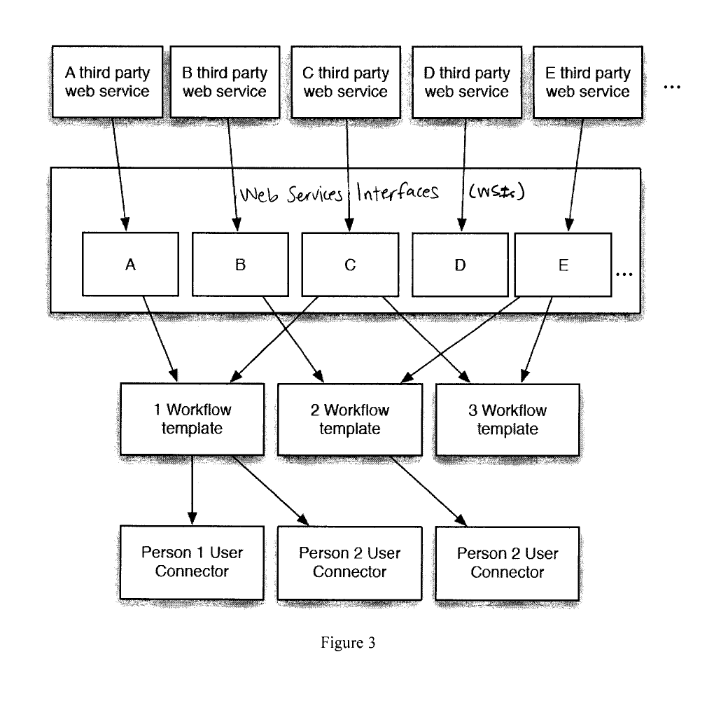

FIG. 3 illustrates an association between a series of user connectors and workflows performed by a system. Referring to FIG. 3, three personalized user connectors are illustrated. One of the user connectors is for Person 1, while two user connectors are for Person 2. The Person 1 user connector consists of workflow template number 1 personalized for Person 1. The first Person 2 user connector consists of workflow template number 1 personalized for Person 2. A second Person 2 user connector consists of workflow template number 2 personalized for Person 2.

As shown in FIG. 3, workflow template number 1 consists of a workflow that makes use of two services. These two services are third-party web service A and third-party web service B. The workflow template number 1 makes use of these two third-party web services through a WSI. Workflow template number 2 consists of a workflow that utilizes third-party web service B and third-party web service E. Workflow template number 3 is a workflow that makes use of third-party web service C and third-party web service E.

In one embodiment, third-party web service A is Dropbox, third-party web service B is Quickbooks, third-party web service C is an Optical Character Recognition (OCR) processing service, and third-party web service E is an invoice processing service. In such a case, the Person 1 user connector is a personalized version of workflow template 1 that comprises of a workflow that uses an OCR service on a document followed by storage of the document in Dropbox. Similarly, the first Person 2 user connector would represent a Dropbox plus OCR connector personalized for Person 2. Workflow template number 2 would represent a workflow that includes invoice processing and the storage of a document in Quickbooks. In such a case, the second Person 2 user connector would be a connector that includes Quickbooks and invoice processing personalized for Person 2.

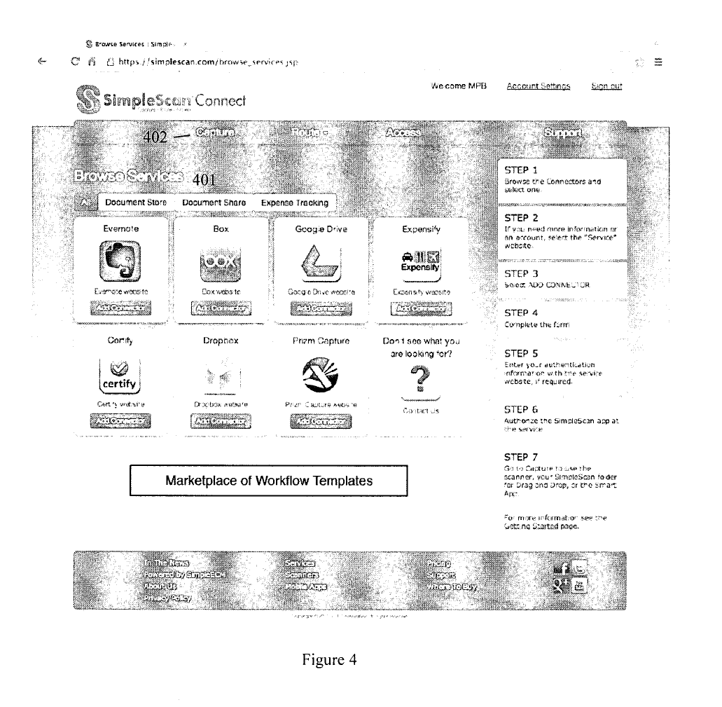

FIG. 4 is one embodiment of a graphical user interface illustrating a marketplace of workflow templates. These templates are selectable and personalizable by a user to utilize one or more third-party web services. Referring to FIG. 4, the browser services window 401 shows a number of workflow templates that are represented as icons. For example, there are icons for workflow templates associated with Evernote, Box, Google Drive, Expensify, Certify, Dropbox, and Prizm Capture. Each of these icons includes a link to a website associated with the third-party web service as well as in “Add Connector” button. From the graphical user interface, the user is able to select workflow templates associated with the services.

In one embodiment, the following process is performed to select and setup the workflow templates. First, a user browses the user connectors and selects one (step one). If the user needs more information or an account, the user selects the third-party web service website and interacts directly with that site (step two). The user then selects an “Add Connector” button (step three) and completes any form that needs to be filled in (step four). In one embodiment, data in the form includes required information such as the title, or nickname, of the new user connector and any data required by the web service. Also, there might be optional information such as, for example, the destination folder at the web service that data should be deposited in. After completing any necessary form, the user enters the web service authentication information with the service website, if required (step five). This is usually an open identification system such as, for example, OAuth.

In one embodiment, the user goes to a capture page by selecting capture button 402 on the graphical user interface to use the scanner or other document capture device. On that page, the connector created can be selected for processing the document capture, or about to be captured (601).

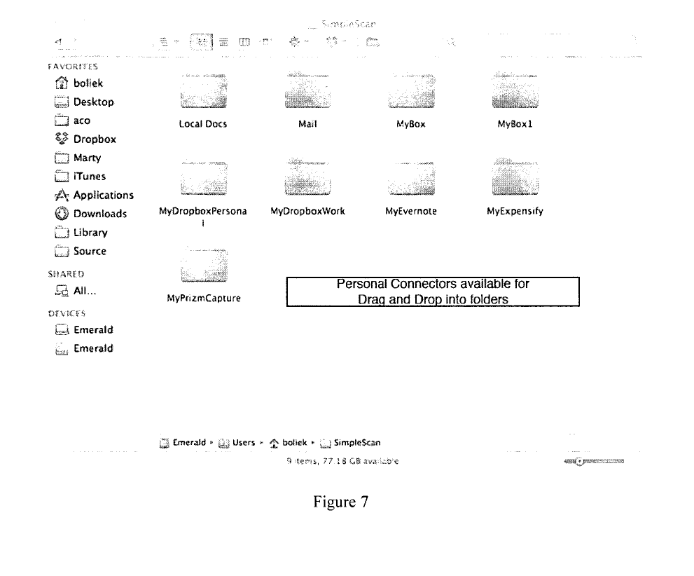

In one embodiment, folders are related to the users connectors with the nickname of the connector being the name of the folder. Any data file dragged and dropped into a nicknamed folder will be processed by that connector (FIG. 7).

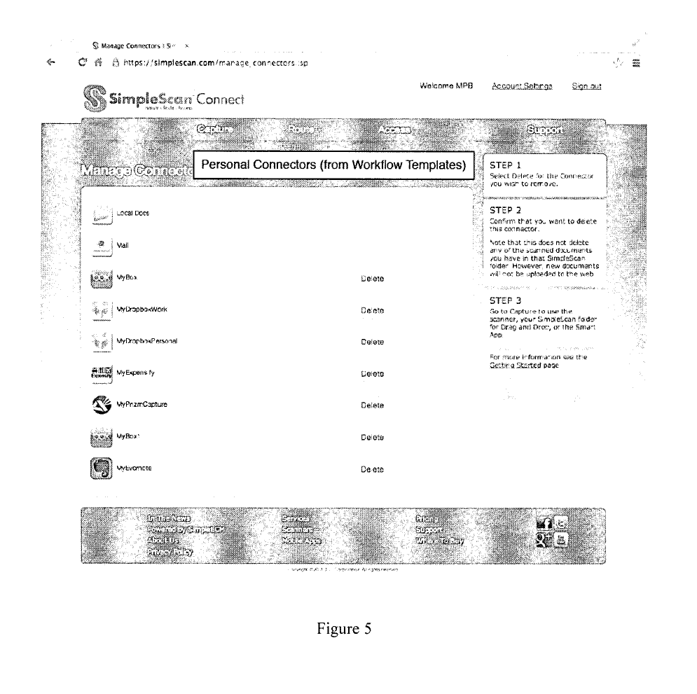

FIG. 5 illustrates a graphical user interface for managing personalized user connectors of an individual. The management of personal connectors includes deleting and/or editing connectors. As shown, user connectors may be deleted using a delete button associated with each of the connectors Likewise, the information defining the operation of the connector can be changed for all uses of the connector by using the edit button.

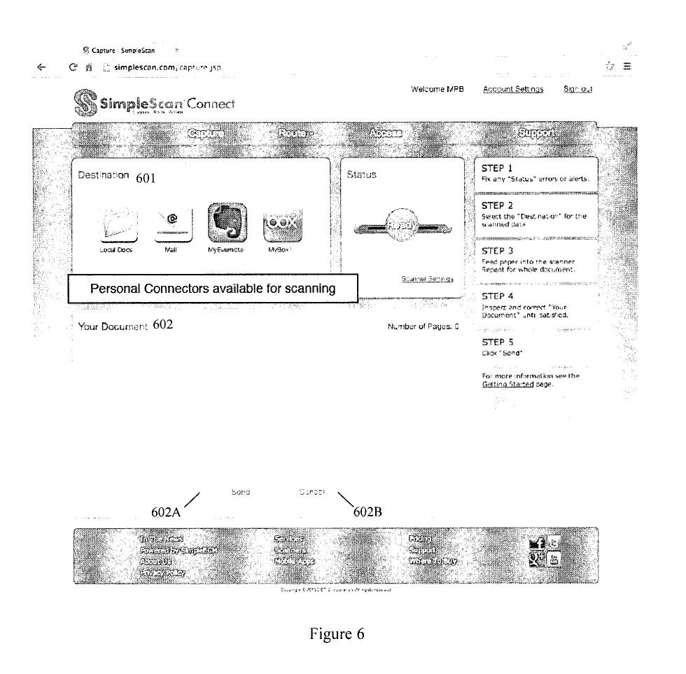

FIG. 6 illustrates an example of a graphical user interface representing a capture page. This may be used by a user to select a personal connector for scanning a document or for a document that has just been scanned. Referring to FIG. 6, destination window 601 allows the user to select the destination for a document being scanned. When a connector is selected, the information defining the operation of the connector can be changed for that single use of the connector. Window 602 displays the document data resulting from use of a data capture device (e.g., document scanner). Through the use of send button 602A, the user is able to send the scanned data to a destination specified in destination window 601. Also, a user may select cancel button 602B to cancel data that has been scanned and prevent it from being sent to a destination selected in destination window 601.

In one embodiment, displaying the capture page initializes the data capture device (e.g., a scanner). Once the paper sensor is triggered, the scan is performed. The connector is associated with the scan once the send button is selected by the user.

In one embodiment, the operations for utilizing the capture page of FIG. 6 include fixing any status errors or alerts that may be displayed on the capture page (step one). After any status errors and alerts have been handled, the user selects the “destination” for the scanned data (step two), feeds paper into the scanner and repeats that process for the entire document that is to be scanned (step three). Thereafter, the user inspects and corrects the document that has been scanned in and depicted in window 602. Once the user is satisfied with the scanned document, the user clicks the send button 602A to send the document to the destination selected in destination window 601.

FIG. 7 illustrates a graphical user interface depicting multiple personal connectors available for performing a drag and drop operation to move captured data into one or more folders. Each of the folders in the graphical user interface is associated with a third-party web service. Referring to FIG. 7, there are a number of folders and the user is able to drag and drop captured data (e.g., a document) into one of the folders. For example, a folder entitled “MyEvernote” is a folder associated with the Evernote web service and documents dragged and dropped into the “MyEvernote folder” would be stored with the Evernote web service. In one embodiment, document and data files can be sourced from anywhere the current computer operating system can reach. These files can be on the local disks, removable memory, removable devices like cameras, and networked file systems.

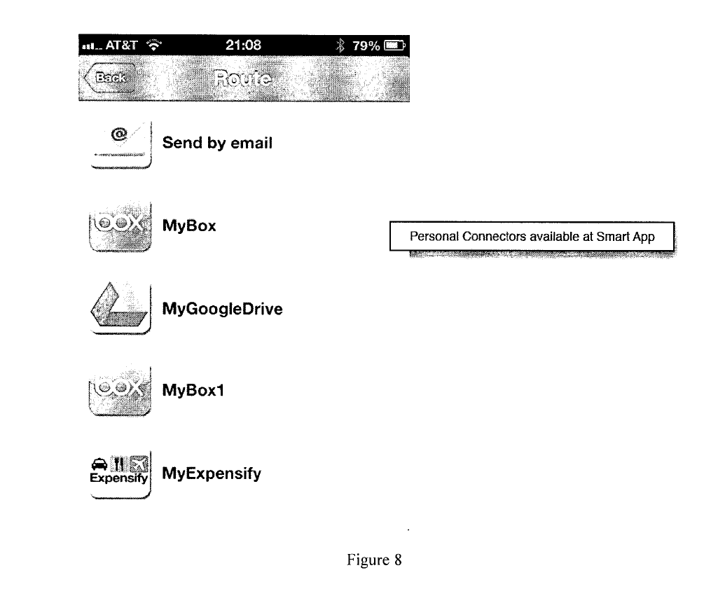

FIG. 8 illustrates one embodiment of a graphical user interface depicting personalized connectors available for a smart application on a smart device, such as a smartphone. Again, each of the personalized connectors is selectable by a user to route a scanned document to the respective web service after the document has been scanned or input into the smart device.

### An Example of a System

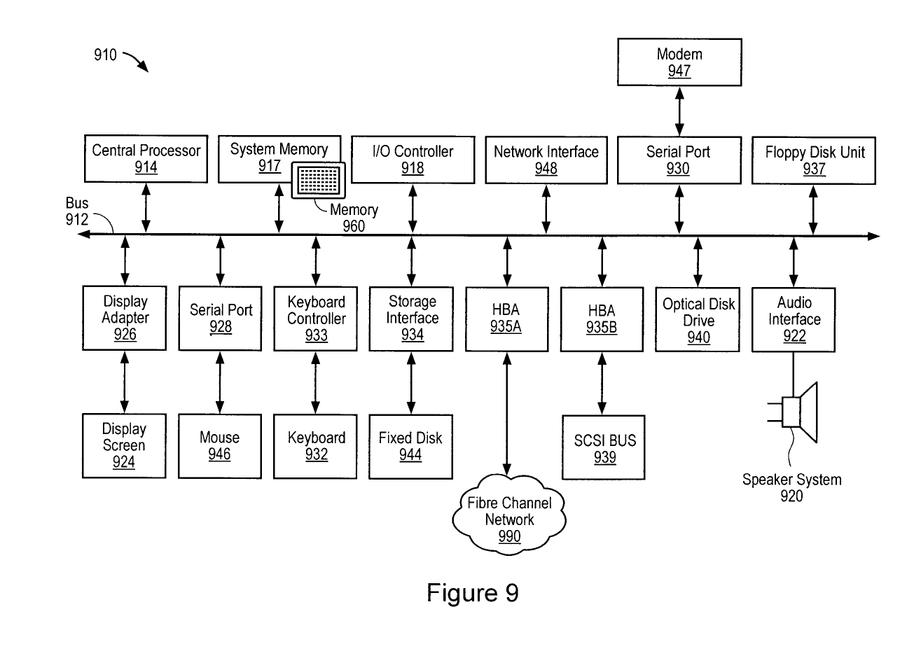

FIG. 9 depicts a block diagram of a server system to perform one or more of the functions described above. For example, in one embodiment, the server system performs operations associated with DIR 102, GW 103 and local browser 104 of FIG. 1, including providing support for the personalized connectors.

Referring to FIG. 9, system 910 includes a bus 912 to interconnect subsystems of security gateway 910, such as a processor 914, a system memory 917 (e.g., RAM, ROM, etc.), an input/output controller 918, an external device, such as a display screen 924 via display adapter 926, serial ports 928 and 930, a keyboard 932 (interfaced with a keyboard controller 933), a storage interface 934, a floppy disk drive 937 operative to receive a floppy disk 938, a host bus adapter (HBA) interface card 935A operative to connect with a Fibre Channel network 990, a host bus adapter (HBA) interface card 935B operative to connect to a SCSI bus 939, and an optical disk drive 940. Also included are a mouse 946 (or other point-and-click device, coupled to bus 912 via serial port 928), a modem 947 (coupled to bus 912 via serial port 930), and a network interface 948 (coupled directly to bus 912).

Bus 912 allows data communication between central processor 914 and system memory 917. System memory 917 (e.g., RAM) may be generally the main memory into which the operating system and application programs are loaded. The ROM or flash memory can contain, among other code, the Basic Input-Output system (BIOS) which controls basic hardware operation such as the interaction with peripheral components. Applications resident with computer system 910 are generally stored on and accessed via a computer readable medium, such as a hard disk drive (e.g., fixed disk 944), an optical drive (e.g., optical drive 940), a floppy disk unit 937, or other storage medium.

Storage interface 934, as with the other storage interfaces of computer system 910, can connect to a standard computer readable medium for storage and/or retrieval of information, such as a fixed disk drive 944. Fixed disk drive 944 may be a part of computer system 910 or may be separate and accessed through other interface systems.

Modem 947 may provide a direct connection to a remote server via a telephone link or to the Internet via an internet service provider (ISP) (e.g., servers 101, 111-114 of FIG. 1). Network interface 948 may provide a direct connection to a remote server such as, for example, servers 111-114 of FIG. 1. Network interface 948 may provide a direct connection to a remote server (e.g., server 101 of FIG. 1) via a direct network link to the Internet via a POP (point of presence). Network interface 948 may provide such connection using wireless techniques, including digital cellular telephone connection, a packet connection, digital satellite data connection or the like.

Many other devices or subsystems (not shown) may be connected in a similar manner (e.g., document scanners, digital cameras and so on). Conversely, all of the devices shown in FIG. 9 need not be present to practice the techniques described herein. The devices and subsystems can be interconnected in different ways from that shown in FIG. 9. The operation of a computer system such as that shown in FIG. 9 is readily known in the art and is not discussed in detail in this application.

Code to implement the operations described herein can be stored in computer-readable storage media such as one or more of system memory 917, fixed disk 944, optical disk 942, or floppy disk 938. The operating system provided on computer system 910 may be MS-DOS®, MS-WINDOWS®, OS/2®, UNIX®, Linux®, or another known operating system.

### Additional Considerations

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

I claim:

1. A method comprising:
directing flow of data collected from a data acquisition device on a network in response to a connector, the connector representing a user selected and parameterized workflow template that specifies one or more web services to perform processing on the data or storage of the data, including
receiving the data after the data acquisition device pushes the data to the network in response to the connector, and
controlling processing flow of the data with at least one of the one or more web services specified by the connector; and
storing the data via one of the one or more web services according to the connector.

2. The method defined in claim 1 wherein the connector is capable of being configured to direct the flow of data from one or any number of data acquisition devices.

3. The method defined in claim 1 wherein the network comprises the web.

4. The method defined in claim 1 further comprising
collecting data at the data acquisition device in response to the connector; and
bundling the data in a file with an indication of the connector.

5. The method defined in claim 4 further comprising sending the indication of the connector to the data acquisition device.

6. The method defined in claim 1 wherein the connector is parameterized with authentication information to enable automatic authentication with at least one cloud web service.

7. The method defined in claim 6 wherein using authentication information is OAuth information.

8. The method defined in claim 1 further comprising creating the connector by:
selecting at least one workflow template from a plurality of workflow templates;
entering authentication information with at least one service website specified by the at least one workflow template;
authorizing a scanning application at the least one service website; and
display a capture page into which the data from the data acquisition device is displayed.

9. The method defined in claim 1 wherein the connector comprises an instruction set containing:
information needed to access at least one web-based cloud service;
information related to an account of the user; and
information explaining the data flow.

10. The method defined in claim 9 wherein the information needed to access the at least one web-based cloud service comprises one or more of login and password information, OAuth key, tags, folders, data formats, and other web service specific information.

11. A system to enable data acquisition devices to push content to a network and control the flow of processing and storage in a variety of cloud web services accessible via the network, the system comprising:
a memory to store software; and
a processor coupled to the memory to execute the software to:
direct flow of data collected from a data acquisition device on a network in response to a connector, the connector representing a user selected and parameterized workflow template that specifies one or more web services to perform processing on the data or storage of the data, including receiving the data after the data acquisition device pushes the data to the network in response to the connector, and controlling processing flow of the data with at least one of the one or more web services specified by the connector; and
store the data via one of the one or more web services according to the connector.

12. The system defined in claim 11 wherein the connector is capable of being configured to direct the flow of data from one or any number of data acquisition devices.

13. The system defined in claim 11 wherein the connector is parameterized with authentication information to enable automatic authentication with at least one cloud web service.

14. The system defined in claim 13 wherein using authentication information is OAuth information.

15. The system defined in claim 11 wherein the connector is created by:
selecting at least one workflow template from a plurality of workflow templates;
entering authentication information with at least one service website specified by the at least one workflow template;
authorizing a scanning application at the least one service website; and
display a capture page into which the data from the data acquisition device is displayed.

16. The system defined in claim 11 wherein the connector comprises an instruction set containing:
information needed to access at least one web-based cloud service;
information related to an account of the user; and
information explaining the data flow.

17. An article of manufacture having one or more non-transitory computer readable storing instructions thereon which, when executed by a system, cause the system to perform a method comprising:
directing flow of data collected from a data acquisition device on a network in response to a connector, the connector representing a user selected and parameterized workflow template that specifies one or more web services to perform processing on the data or storage of the data, including
receiving the data after the data acquisition device pushes the data to the network in response to the connector, and
controlling processing flow of the data with at least one of the one or more web services specified by the connector; and
storing the data via one of the one or more web services according to the connector.

18. The article of manufacture defined in claim 17 further comprising
collecting data at the data acquisition device in response to the connector; and
bundling the data in a file with an indication of the connector.

19. The article of manufacture defined in claim 17 wherein the connector is parameterized with authentication information to enable automatic authentication with at least one cloud web service.

20. The article of manufacture defined in claim 17 wherein the method further comprises creating the connector by:
selecting at least one workflow template from a plurality of workflow templates;
entering authentication information with at least one service website specified by the at least one workflow template;
authorizing a scanning application at the least one service website; and
display a capture page into which the data from the data acquisition device is displayed.
